(19) United States
(12) Patent Application Publication
(10) Pub. No.: US 2019/0288272 A1
(43) Pub. Date: Sep. 19, 2019

(54) Method of making active electrode and ceramic separator in battery

(71) Applicants: Jingzeng Zhang, Windsor (CA); Yining Nie, New York, NY (US); Xueyuan Nie, Windsor (CA)

(72) Inventors: Jingzeng Zhang, Windsor (CA); Yining Nie, New York, NY (US); Xueyuan Nie, Windsor (CA)

(21) Appl. No.: 15/924,212

(22) Filed: Mar. 17, 2018

(51) Int. Cl. H01M 4/04; H01M 4/134; H01M 4/48; H01M 2/14; H01M 2/16; H01M 10/0525; H01M 10/054; H01M 10/052

(52) U.S. Cl. CPC H01M 4/0442; H01M 4/134; H01M 4/483; H01M 10/052; H01M 2/1646; H01M 10/0525; H01M 10/054; H01M 2/145

(57) ABSTRACT

This invention involves a method of making an electrode and a ceramic separator for use in batteries using a plasma oxidation process. The electrode is a metallic sheet that undergoes plasma oxidation, through which active materials are grown and metallurgically bonded to the metallic sheet. The plasma oxidation method is also used to make a ceramic separator. The electrode is assembled into a conventional battery cell or a hybrid battery cell. In a conventional battery, the said electrode is used as an anode or a cathode. In a hybrid battery, the said electrode is used as a cathode, a thin lithium metal sheet is an anode, the said separator is inserted between the cathode and the anode, and an electrolyte is held within the separator.

### TECHNICAL FIELD

This invention involves a method of forming metallurgically-bonded active materials on battery cell electrodes and forming battery cell ceramic separators using a plasma oxidation process. Without the need for binders and adhesives for the integration of active materials onto the electrode, the power density and durability of the battery cells can be improved.

### BACKGROUND OF THE INVENTION

Batteries are finding increasing applications, including use in electronics, residential energy storage, and electric vehicles. A single lithium ion cell or sodium ion cell in a battery provides an electrical potential of about three to five volts and a direct electrical current. Many cells are needed to form batteries powerful enough to satisfy voltage and current requirements in electric motors; individual cells are combined in various arrangements of parallel and series connections.

Each lithium ion cell typically comprises a negative electrode (anode); a positive electrode (cathode); a thin porous separator inserted between the electrodes; and a liquid, lithium-containing, electrolyte solution that fills the pores of the separator and transports lithium ions between the inward surfaces of the electrodes during repeated cell discharge and re-charge cycles. Each electrode consists of a layer of active materials typically deposited as a wet mixture on a metallic current collector.

In a conventional lithium ion battery (LIB), for instance, the negative electrode is formed by spreading a thin layer of graphite or lithium titanate particles and a polymeric binder onto a thin copper foil, which acts as the current collector for the negative electrode. The positive electrode contains a thin layer of a resin-bonded, porous, particulate lithium-metal-oxide composition spread on and bonded to a thin aluminum foil which serves as the current collector for the positive electrode. Therefore, both of the electrodes are made by dispersing mixtures of their respective binders and active particulate materials in a solvent; depositing the wet mixture as a coating layer on the surface of a current collector foil; and drying, pressing, and fixing the resin-bonded electrode particles to their respective current collector surfaces. Sodium ion batteries (SIBs) have a similar cell structure to LIBs but contain sodium-based active materials.

However, active material binders may become degraded during the cycles of charge and discharge, leading to separation of the active materials from the current collectors and thus gradual loss of the energy and power densities of LIBs and SIBs. The binders also limit cell performance particularly at temperatures below freezing or above 60 degrees Celsius. There is a need for binder-free LIB and SIB electrodes that retain power density and functionality at a wide range of temperatures.

### SUMMARY OF THE INVENTION

The invention hereby relates to a plasma oxidation process that can make a binder-free electrode and a ceramic separator for use in battery cells. The electrode is produced by growing active materials on the surface of a metallic sheet on which high current and high voltage are applied to generate plasma discharge in an aqueous solution. The aqueous solution contains chemical elements for the formation of active materials. The active materials are metallurgically grown in-situ on the electrode sheet surface in a single operation.

In this invention, the method of making a binder-free electrode comprises:
(i) preparing an aqueous solution containing chemical substance A;
(ii) applying said solution onto one surface of a metallic sheet B;
(iii) applying an electrical power with high current and high voltage onto said metallic sheet;
(iv) generating plasma discharge on the surface of said metallic sheet; and
(v) forming an oxide layer C on the surface of the said metallic sheet.

The said oxide layer C functions as active materials, and the said metallic sheet B and the said oxide layer together function as an electrode.

The said substance A is a compound containing cobalt (Co), manganese (Mn), molybdenum (Mo), nickel (Ni), titanium (Ti), aluminium (Al), copper (Cu), lithium (Li), carbon (C), graphene, silicon (Si), phosphorous (P), or sulfur (S); the said metallic sheet B is made of aluminum (Al), titanium (Ti), zirconium (Zr), niobium (Nb), magnesium (Mg) metals, or their alloys; the said oxide layer C contains one or more compounds of metal oxides, phosphates, silicates, metal phosphides, metal sulphides, metal nitrides, titanate, graphite, porous carbon, nanotube, graphene, or silicon-based materials such as silicon, silicon alloys, and SiOₓ.

In one exemplary embodiment of this invention, the aqueous solution preferably contains 1-100 grams/litre of substance A comprising at least one of cobalt salt, manganese salt, nickel salt, copper salt, aluminum salt, lithium salt, silicate, phosphate and soluble niobium compounds.

In the invention, the said metallic sheet B is preferably made of thin Ti, Al or Zr foil with a thickness of 5-100 microns.

In the invention, the said aqueous solution can contact one or two sides of the surfaces of the metallic foil. For a case where only one side of the foil is required to be treated, the relevant side of the metallic foil is exposed to the said aqueous solution while the other side of the foil is masked; the said aqueous solution can also be applied onto one surface of the metallic foil through a spraying head with a pumping system. The foil is electrically connected to a power supply; when a high current density of 0.04-0.8 A/cm² and a high voltage of 100-700V are applied between the spraying head and the metallic foil, electrical plasma discharge is generated on the surface of the foil facing the spraying head. Plasma oxidation reaction due to the electrical discharge takes place on the surface, forming an oxide layer C on the top of the metallic foil.

In the invention, the said oxide layer C is a compound of titanium cobalt oxide, manganese nickel cobalt oxide, titanium oxide, manganese oxide, cobalt oxide, nickel cobalt aluminum oxide, titanium aluminum oxide, titanium silicon oxide, aluminum silicon oxide, titanium cobalt phosphor oxide, titanium cobalt silicon phosphor oxide, titanium aluminum silicon phosphor oxide, nickel manganese oxide, nickel copper manganese titanium oxide, iron phosphate, phosphates, silicates, metal phosphides, metal sulphides, metal nitrides, titanate, graphite, carbon, porous carbon, graphene, and silicon-based materials such as silicon, silicon alloys, and SiOₓ. as well as of lithium or sodium compound. The oxide layer preferably has a thickness of 5-100 microns.

In the invention, the said oxide layer C has a porous, foam-like structure; is metallurgically bonded on the metallic foil; and functions as active materials. The metallic foil with the oxide layer preferably on one of its surfaces functions as a binder-free electrode. The metallic foil with the oxide layer on both of its surfaces functions as a binder-free bipolar electrode.

In the invention, the same plasma oxidation process can be used to make a ceramic separator. As an embodiment of this invention, Al foil can be oxidized, through the plasma oxidation process, to become porous aluminum oxide or aluminum silicon oxide in an aqueous solution; the aqueous solution is prepared by dissolving 4-40 grams/litre aluminate or silicate in water. The porous aluminum oxide or aluminum silicate oxide can be used as a separator.

In the invention, the electrode is assembled into either a conventional battery cell or a hybrid battery cell. In a conventional battery, the said electrode is used as an anode or cathode, replacing the commonly-used anode made of a graphite-silicon-binder mixture or cathode made of a lithium salt-binder mixture (for LIBs) or sodium salt-binder mixture (for SIBs). In a hybrid lithium metal-lithium ion battery or a supercapacitor battery, the said electrode is a cathode, a thin lithium metal sheet is an anode, the said ceramic separator is inserted between the cathode and the anode, and an electrolyte is held within the separator.

### BRIEF DESCRIPTION OF THE DRAWINGS

FIG. 1 is a schematic illustration of a plasma oxidation process for making active materials on a metallic foil to be used as an electrode in accordance with embodiments.

FIGS. 2A and 2B are schematic illustrations of a plasma oxidation process for making a ceramic separator in accordance with embodiments.

FIG. 3 is a schematic illustration of an electrode with active materials in accordance with embodiments.

FIG. 4 is a schematic illustration of a porous ceramic separator in accordance with embodiments.

FIGS. 5A and 5B are schematic illustrations of arrangements of the said electrode in a conventional lithium ion battery and sodium ion battery in accordance with embodiments.

FIG. 6 is a schematic illustration of an arrangement of the said electrode in a hybrid battery in accordance with embodiments.

FIG. 7 is a schematic illustration of a modified version of said electrode with active materials and an oxide inner layer in accordance with embodiments.

FIG. 8 is a schematic illustration of an arrangement of the said modified electrode and the said separator in a hybrid battery in accordance with embodiments.

### DETAILED DESCRIPTION OF THE INVENTION

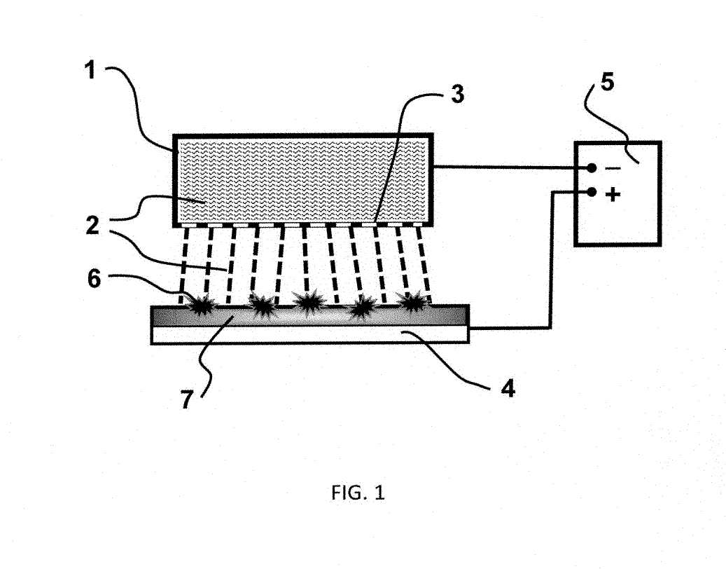

Referring to the schematic illustration in FIG. 1, a metallic spraying head 1 sprays an aqueous solution 2 through nozzles 3 onto one surface of a metallic sheet foil 4; the solution 2 fills the gap between the nozzles 3 and the metallic foil 4; and when a power supply 5 applies high electrical current and voltage between the spraying head 1 and the foil 4, plasma discharges 6 are generated on the surface of the foil 4 where an oxide layer 7 is formed as a result of plasma oxidation. The oxide layer 7 is used as active materials.

As an alternative arrangement, the metallic sheet foil 4 can be masked on one side and then directly immersed into the solution 2 to generate plasma discharge 6 on the side that is exposed to the solution 2. The metallic foil 4 is connected preferably to the positive terminal of a power supply 5 and a current is applied with a density of 0.04-0.8 A/cm² and voltage of 100-700 V. A pulsed bipolar DC power supply is preferable for the plasma oxidation process.

The aqueous solution 2 contains 1-100 grams/litre of substances comprising at least one of cobalt salt, such as cobalt acetate, cobalt acetylacetonate, cobalt fluoride, cobalt sulfate, sodium cobalt oxide, sodium cobaltinitrite, or potassium cobalt oxide; titanium salt, such as titanium acetate, titanium oxalate, or titanium sulfate; manganese salt, such as manganese acetate, manganese acetylacetonate, or manganese sulfate; nickel salt, such as nickel acetate, nickel acetylacetonate or nickel sulfate; copper salt, such as copper acetate, copper acetylacetonate or copper sulfate; aluminum salt, such as sodium aluminate, and potassium aluminate; lithium salt; and soluble niobium compounds, silicate, or phosphate.

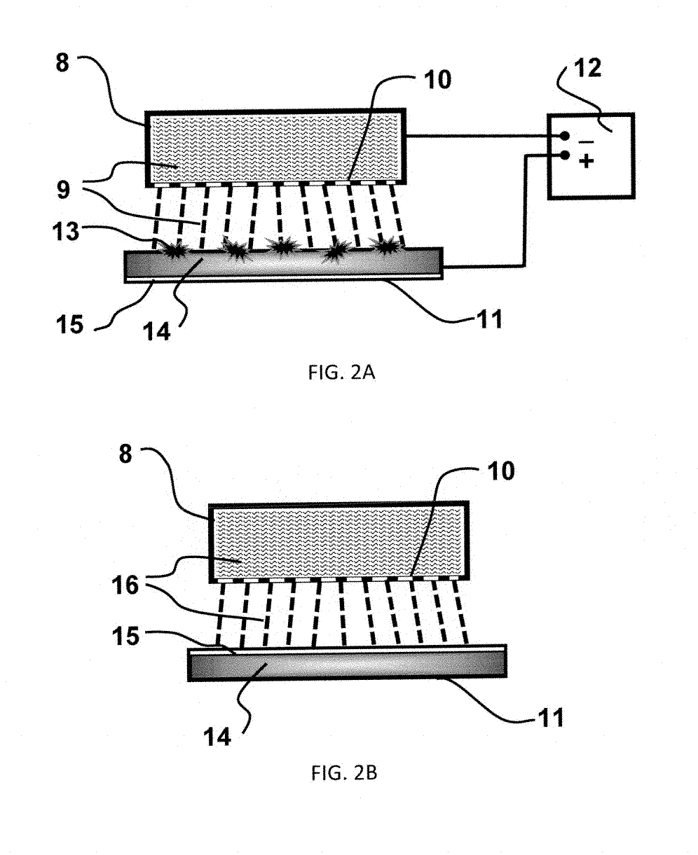

Referring to the schematic illustration in FIG. 2A, a metallic spraying head 8 sprays an aqueous solution 9 through nozzles 10 onto one or both surfaces of a metallic sheet foil 11; the solution 9 fills the gap between the nozzles 10 and the metallic foil 11; and when a power supply 12 applies high electrical current and voltage between the spraying head 8 and the foil 11, plasma discharges 13 are generated on the surface of the foil 11 which turns the foil 11 into an oxide ceramic sheet 14 to be used as a separator.

The aqueous solution 9 is prepared by dissolving 4-40 grams/litre of aluminate or silicate in water. The electrical power 12 applied on the metallic sheet foil 11 is in a current density of 0.05-0.5 A/cm² and voltage of 100-700 V. A pulsed bipolar DC power supply is preferable for the plasma oxidation process.

In the case where only one side of the metallic foil 11 undergoes plasma oxidation and is thus transformed into ceramic materials 14; the remaining side of the foil 11 may have a thin layer of non-oxidized metallic material 15. The remaining metallic material 15 can be etched away using an alkaline solution 16 such as potassium hydroxide (KOH) or sodium hydroxide (NaOH) as shown in the schematic illustration in FIG. 2B; after etching, the entire metallic foil 11 becomes a ceramic sheet.

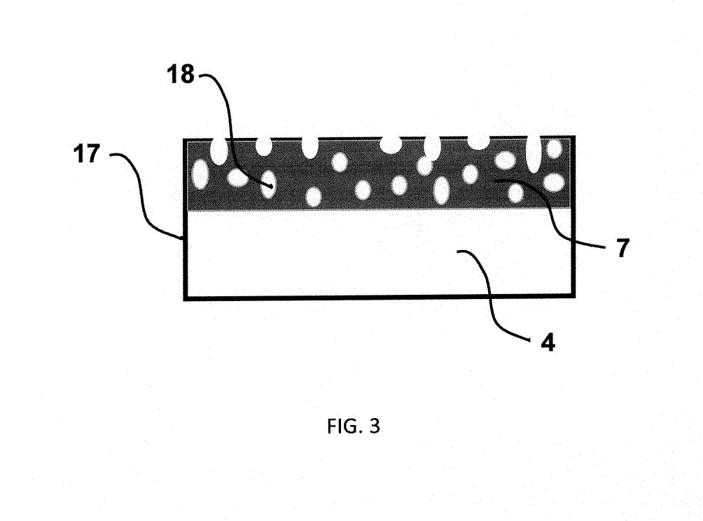

Referring to the schematic illustration in FIG. 3, an electrode 17, prepared using the plasma oxidation process described in FIG. 1, comprises porous active oxide materials 7 on a metallic foil 4. The active materials 7 can have up to 65% percent of porosity 18. The active materials 7 are compounds which comprise at least one of titanium cobalt oxide, manganese nickel cobalt oxide, manganese oxide, cobalt oxide, nickel cobalt aluminum oxide, nickel copper manganese titanium oxide, titanium cobalt phosphor oxide, titanium cobalt silicon phosphor oxide, titanium aluminum silicon phosphor oxide, iron phosphate, metal phosphides, metal sulphides, metal nitrides, phosphates, titanate, lithium titanium cobalt oxide, lithium manganese nickel cobalt oxide, lithium manganese oxide, lithium cobalt oxide, lithium nickel cobalt aluminum oxide, lithium nickel copper manganese titanium oxide, lithium iron phosphate, lithium metal phosphides, lithium metal sulphides, lithium metal nitrides, lithium phosphates, lithium titanate, lithium silicate, sodium titanium cobalt oxide, sodium manganese nickel cobalt oxide, sodium manganese oxide, sodium cobalt oxide, sodium nickel cobalt aluminum oxide, sodium nickel copper manganese titanium oxide, sodium iron phosphate, sodium metal phosphides, sodium metal sulphides, sodium metal nitrides, sodium phosphates, sodium titanate, sodium silicate, graphite, carbon, porous carbon, graphene, nanotube, and silicon-based materials such as silicon, silicon alloys, and SiOₓ. The active materials 7 has a thickness of 5-100 microns, which can be up to two-thirds of the thickness of the electrode 17.

In the invention, the electrode 17, having active materials 7 metallurgically bonded on the metallic foil 4, is binder-free, which can significantly reduce resistance of ion transportation in a battery and thus prevent overheating during the charge and discharge operations.

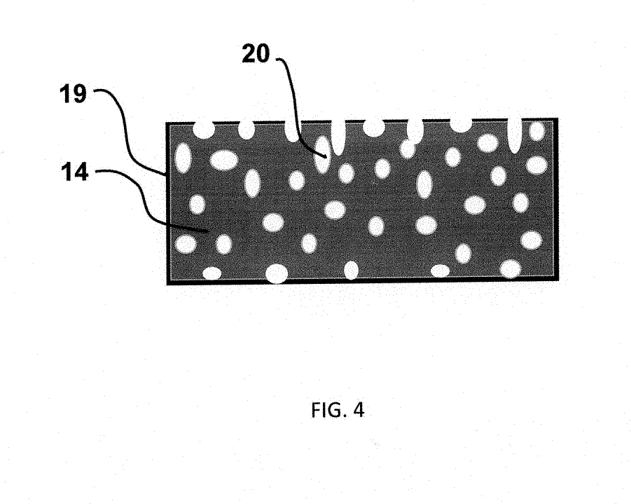

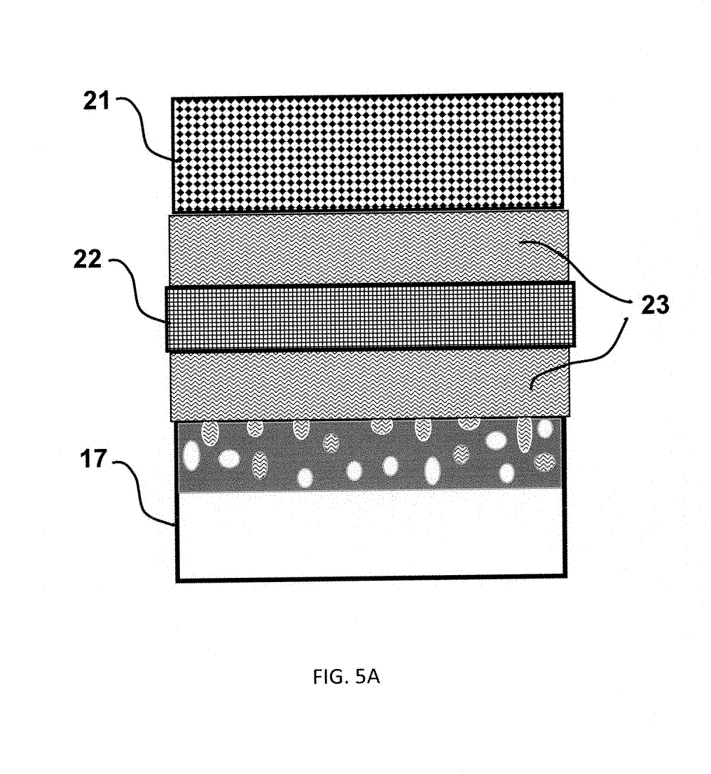

Referring to the schematic illustration in FIG. 4, a ceramic separator 19, prepared using the plasma oxidation process described in FIG. 2, is a porous ceramic sheet 14. 5-45% percent of the sheet volume are pores 20. The porous ceramic separator 19 has a superhydrophilic surface. The superhydrophilic surface and pores can hold electrolytes within the separator.

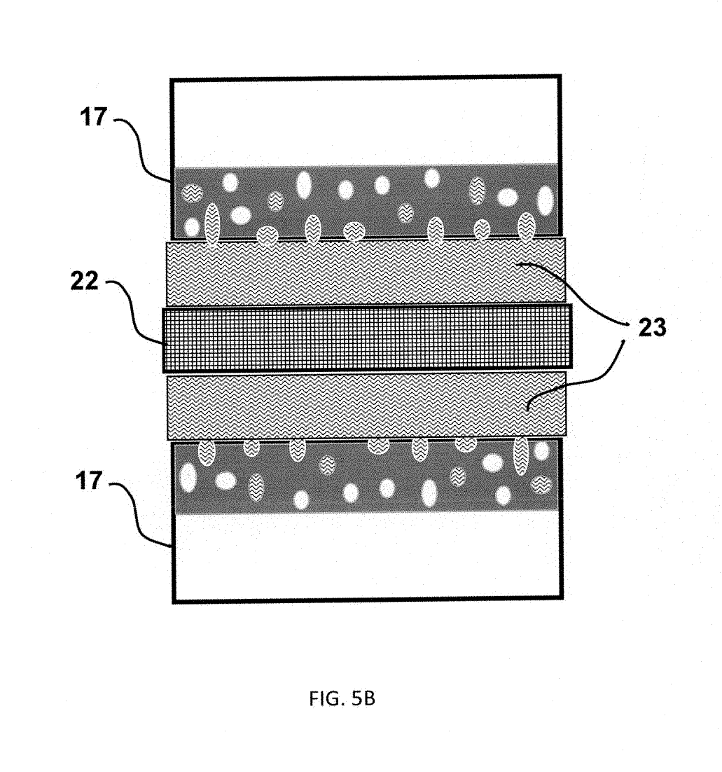

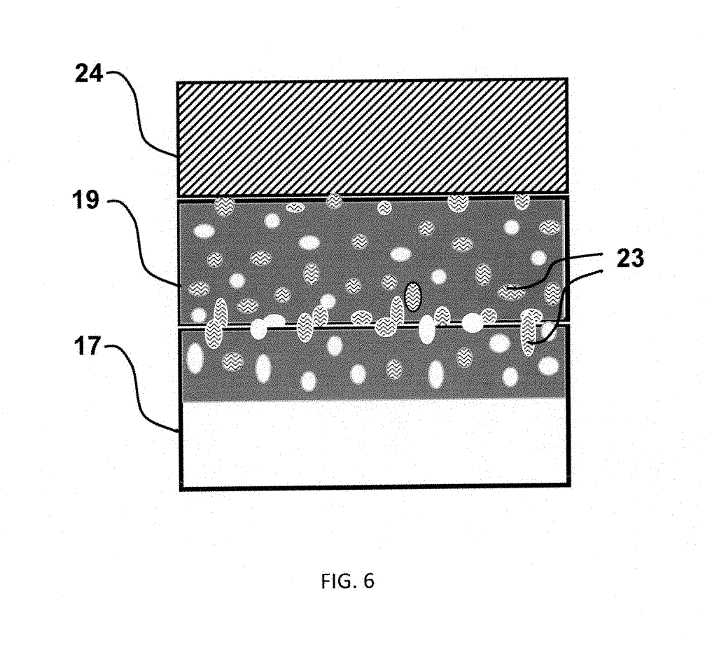

Referring to the schematic illustration in FIG. 5A, the active electrode 17 is assembled into a conventional lithium or sodium ion battery which includes the active electrode 17 as an anode, porous lithium or sodium metal oxides as a cathode 21, a porous polymer separator 22, and a liquid electrolyte 23. Alternatively, the active electrode 17 is assembled into a conventional lithium ion battery with the active electrode 17 cathode, porous carbon-graphene-silicon anode 21, a porous polymer separator 22, and a liquid electrolyte 23. Alternatively, as shown in FIG. 5B, active materials may be incorporated in both the anode 17 and the cathode 17.

Referring to the schematic illustration in FIG. 6, the active electrode 17 is assembled into a hybrid lithium metal-lithium ion battery which includes the active electrode 17 as a cathode; a lithium metal sheet 24 as an anode; a solid ceramic separator 19, a porous polymeric separator 22 or combined ceramic 19 and polymer 22 separator; and a liquid electrolyte 23.

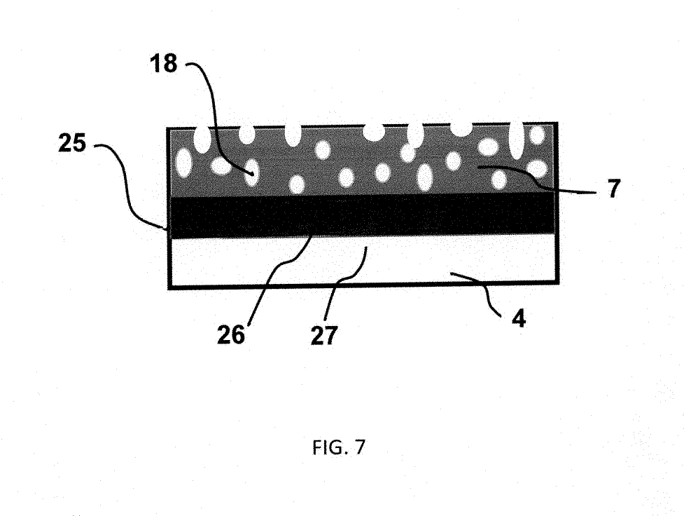

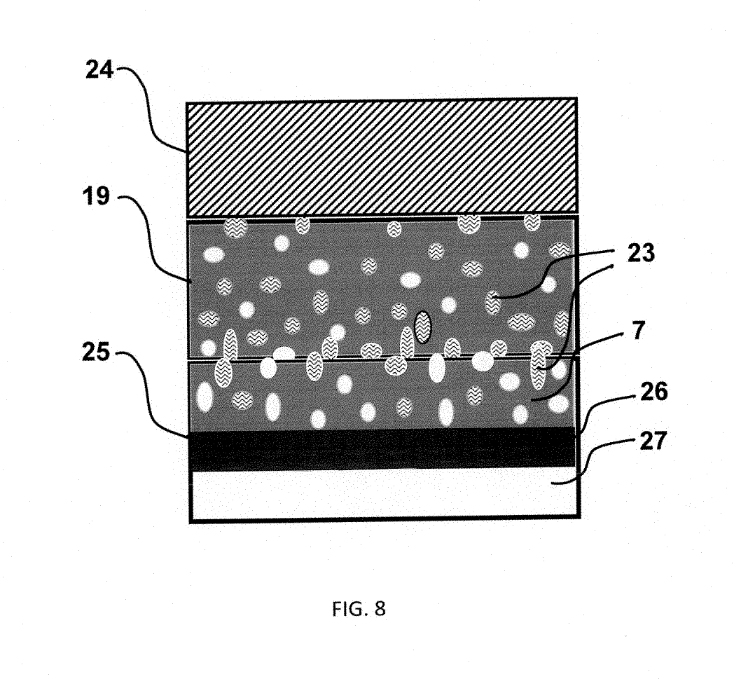

Referring to the schematic illustration in FIG. 7, a modified electrode 25, prepared using the plasma oxidation process described in FIG. 1, comprises porous active oxide materials 7 and a dense inner oxide layer 26 on a metallic foil 4. The active materials 7 has a thickness of 5-100 microns and up to 65% percent porosity 18. The inner oxide layer 26 is 0.01-20 microns thick and has a porosity of less than 5%. An oxide layer 26 0.01-5.0 microns in thickness can function as an insulating thin layer to block the transporting of electrons to the active materials 7 to prevent metal dendrite formation. An oxide layer 26 5-20 microns in thickness can function as an insulating separator for a capacitor. The metallic part 27 of the foil 4 is 5-50 microns in thickness and can function as a part of a capacitor battery.

Referring to the schematic illustration in FIG. 8, the electrode 25 and the ceramic separator 19 are assembled into a hybrid supercapacitor lithium battery which includes the electrode 25 as a cathode and capacitor, a lithium metal sheet as an anode 24, a porous ceramic separator 19, and a liquid electrolyte 23. The side of the electrode 25 with active oxide materials 7 is used as a cathode for battery functionality, and the side with a metallic backup 27 is used as one of capacitor plates for supercapacitor functionality.

According to embodiments of the invention, the precursor material for the said electrode or the said separator is a metallic sheet foil made of aluminum (Al), titanium (Ti), zirconium (Zr), niobium (Nb), magnesium (Mg) metals, or their alloys.

According to embodiments of the invention, the said active materials are preferably made from a titanium foil or a zirconium foil which is used as electrode. The foil has a thickness of 5-100 microns, and the active materials have a thickness of 10-100 microns. The Ti or Zr electrode with active materials is used as an anode in a lithium ion battery or a cathode in a lithium metal battery. The Ti or Zr electrode having active materials on both of its sides can be used as a bipolar electrode.

According to embodiments of the invention, the said active materials are preferably made from an aluminum foil which is used as electrode. The aluminum foil has a thickness of 5-100 microns, and the active materials have a thickness of 10-100 microns. The Al electrode with active materials is used as a cathode in a lithium ion or sodium ion battery. The Al electrode having active materials on both of its sides can be used as a bipolar electrode.

According to embodiments of the invention, the Ti or Zr electrode with active materials is used as an anode and the Al electrode with active materials is used as a cathode in a lithium ion battery.

According to embodiments of the invention, the said active materials are preferably made from aluminum foils which are used as electrodes. The aluminum foil has a thickness of 5-100 microns, and the active materials have a thickness of 10-100 microns. The Al electrodes with active materials can be used as an anode and a cathode in a sodium ion battery.

According to embodiments of the invention, the said electrode with active materials have a foam-like structure and is metallurgically bonded on the metallic foil is binder-free.

According to embodiments of the invention, the said electrode does not induce delamination of active materials from the Ti, Zr or Al metallic foil during the charging or discharging of a lithium ion or metal battery.

According to embodiments of the invention, the said electrode can be made from a long strip or coil of a metallic foil and then cut, folded, rolled, or shaped into the dimensions required in different battery designs.

According to embodiments of the invention, the said ceramic separator is preferably made from an aluminum foil. The aluminum foil has a thickness of 10-50 microns, which is transformed into a porous ceramic sheet. In the case where only one side of the aluminum foil undergoes the said plasma oxidation process, the remaining side which has a layer of metallic aluminum can be etched away using a potassium hydroxide (KOH) or sodium hydroxide (NaOH) solution. In the case where both sides of the aluminum foil undergo the said plasma oxidation process, the central part of the foil may still have some residual metallic aluminum. The remaining metallic aluminum can be also etched away using a potassium hydroxide (KOH) or sodium hydroxide (NaOH) solution.

According to embodiments of the invention, the said ceramic separator has pores which are not always directly connected. The separator, which has high hardness, resists damage from any metal dendrites that may be formed during the charging and discharging of a lithium ion or metal battery, preventing short-circuiting of the battery.

According to embodiments of the invention, the lithium batteries can have a specific energy density of 500-1800 W·h/kg or power density of 500-1800 W/kg. The batteries allow high-speed charging and discharging in a wide temperature range without significant reduction in efficiency or durability.

According to embodiments of the invention, several battery units as described above can be stacked to form a multilayered battery in a single cell package. The batteries can be connected in series or in parallel to meet the current and voltage requirements of different applications such as powering electronic devices, electrical motors for vehicles, electrical energy storage, among others.

1. A method of making an electrode of a battery, comprising:
(i) preparing an aqueous solution containing chemical substance A;
(ii) applying said solution onto one or both surfaces of a metallic sheet B;
(iii) applying an electrical power with high current and high voltage onto said metallic sheet;
(iv) generating plasma discharge on the surface of said metallic sheet; and
(v) forming an oxide layer C on the surface of the said metallic sheet.

2. The method according to claim 1, wherein the chemical substance A is a compound containing cobalt (Co), manganese (Mn), molybdenum (Mo), nickel (Ni), titanium (Ti), aluminium (Al), copper (Cu), lithium (Li), carbon (C), graphene, silicon (Si), phosphorous (P), or sulfur (S).

3. The method according to claim 1, wherein the metallic sheet B is a foil made of titanium (Ti), aluminum (Al), zirconium (Zr), niobium (Nb), magnesium (Mg) metals, or their alloys.

4. The method according to claim 1, wherein the electrical power applied has a current density of 0.04-0.8 A/cm² and voltage of 100-700 V.

5. The method according to claim 1, wherein the oxide layer C contains one or more compounds of titanium cobalt oxide, titanium cobalt phosphor oxide, titanium cobalt silicon phosphor oxide, titanium copper cobalt oxide, titanium copper oxide, titanium molybdenum oxide, titanium copper molybdenum cobalt oxide, manganese nickel cobalt oxide, manganese oxide, cobalt oxide, nickel cobalt aluminum oxide, nickel copper manganese titanium oxide, titanium aluminum oxide, titanium silicon oxide, aluminum silicon oxide, titanium aluminum silicon phosphor oxide, iron phosphate, metal phosphides, metal sulphides, metal nitrides, titanate, lithium titanium cobalt oxide, lithium titanium cobalt phosphor oxide, lithium titanium cobalt silicon phosphor oxide, lithium titanium copper cobalt oxide, lithium titanium copper oxide, lithium titanium molybdenum oxide, lithium titanium copper molybdenum cobalt oxide, lithium manganese nickel cobalt oxide, lithium manganese oxide, lithium cobalt oxide, lithium nickel cobalt aluminum oxide, lithium nickel copper manganese titanium oxide, lithium iron phosphate, lithium metal phosphides, lithium metal sulphides, lithium metal nitrides, lithium titanate, lithium silicate, lithium phosphate, lithium carbon, lithium silicon, lithium metal alloys, sodium titanium cobalt oxide, sodium titanium cobalt phosphor oxide, sodium titanium cobalt silicon phosphor oxide, sodium titanium copper cobalt oxide, sodium titanium molybdenum oxide, sodium titanium copper molybdenum cobalt oxide, sodium manganese nickel cobalt oxide, sodium manganese oxide, sodium cobalt oxide, sodium nickel cobalt aluminum oxide, sodium nickel copper manganese titanium oxide, sodium iron phosphate, sodium metal phosphides, sodium metal sulphides, sodium metal nitrides, sodium titanate, sodium silicate, sodium phosphate, sodium carbon, sodium silicon, sodium metal alloys, graphite, porous carbon, graphene, nanotube, or silicon-based materials such as silicon, silicon alloys, and SiOₓ.

6. The method according to claim 1, wherein the said oxide layer C functions as active materials, and the said metallic sheet B and the said oxide layer together function as an electrode.

7. The method according to claim 1, wherein the active oxide materials have a thickness preferably in the range of 10-100 microns.

8. The method according to claim 1, wherein the active oxide materials have a porosity of 10%-65%.

9. The method according to claim 1, wherein the said electrode is used as an anode in a lithium ion or sodium ion battery cell or as a cathode in a lithium metal or sodium metal battery cell.

10. The method according to claim 1, wherein the said electrode made preferably from Ti foil or Zr foil is used as an anode in a lithium ion battery cell or as a cathode in a lithium metal battery cell.

11. The method according to claim 1, wherein the said electrode made preferably from Al foil is used as a cathode in a lithium ion or lithium metal battery cell.

12. The method according to claim 1, wherein the said electrode made preferably from Al foil is used as a cathode or an anode in a sodium ion battery cell.

13. The method according to claim 1, wherein the said active materials on both surfaces of the said electrode made preferably from Ti, Zr or Al foil is used as a bipolar electrode in a lithium or sodium battery cell.

14. A method of making a separator of a battery, comprising:
(i) preparing an aqueous solution;
(ii) applying said solution onto one or both surfaces of a metallic sheet;
(iii) applying an electrical power with high current and high voltage onto said metallic sheet;
(iv) generating plasma discharge on the surface of said metallic sheet; and
(v) transforming the said metallic sheet into an oxide ceramic sheet.

15. The method according to claim 14, wherein the aqueous solution is prepared by dissolving 4-40 grams/litre of aluminate or silicate in water.

16. The method according to claim 14, wherein the metallic sheet is preferably made of Al foil.

17. The methods according to claims 1 and 14, wherein the said electrode and said separator can be made from a long strip or coil of a metallic foil and then cut, folded, rolled, or shaped into the dimensions required for different battery designs.

18. The methods according to claims 1 and 14, wherein the said electrode and said separator are assembled into a battery cell in which the said electrode is a cathode or an anode, the said ceramic separator is inserted between the cathode and the anode, and an electrolyte is held within the separator.

19. The methods according to claims 1 and 14, wherein the said electrode and said separator are assembled into a battery cell in which the said electrode is a cathode, a thin lithium metal sheet is an anode, the said ceramic separator is inserted between the cathode and the anode, and an electrolyte is held within the separator.

20. The method according to claims 1 and 14, wherein the assembled battery cell structure can be stacked to form a multilayered battery in a single cell package.
